(19) United States
(12) Patent Application Publication
(10) Pub. No.: US 2009/0324881 A1
(43) Pub. Date: Dec. 31, 2009

(54) Adhesive surface structure of optical components

(75) Inventor: Shinichi Takeuchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/385,005

(22) Filed: Mar. 27, 2009

(30) Foreign Application Priority Data
Jun. 30, 2008 (JP) 2008-170631

(51) Int. Cl. B32B 3/30; B32B 3/10

(52) U.S. Cl. 428/131; 428/156

(57) ABSTRACT

An adhesive surface structure of an optical component includes a plurality of ridge portions extending linearly and radially from one point on an adhesive surface, and valley portions formed in a configuration that a central line between respective ridge portions inclines to be away from an adherend surface as it goes away from the one point.

### CROSS-REFERENCE TO RELATED APPLICATION

This application is based upon and claims the benefit of priority of the prior Japanese Patent Application No. 2008-170631, filed on Jun. 30, 2008, the entire contents of which are incorporated herein by reference.

### FIELD

The present invention relates to adhesive technology for securing optical components (optical elements).

### BACKGROUND

With recent optical communication becoming high speed and large capacity, the switching scale of an optical switch in an optical cross-connect apparatus or the like used in a trunk line system also becomes high speed and huge. Therefore for optical switches that further require such high speed and large scale, development of an optical switch that uses a micro tilt mirror array adopting a Micro-Electro-Mechanical System (MEMS) is being promoted (refer to reference document 1 and reference document 2).
Reference document 1: “Fully Provisioned 112×112 Micro-Mechanical Optical Crossconnect With 35.8 Tb/s Demonstrated Capacity”, D. T. Neilson et. al., Optical Fiber Communications Conference (OFC 2000), Postdeadline paper PD-12, March 2000.
Reference document 2: International Publication No. WO2000/020899

In such an optical switch, various types of optical components such as a lens, a prism, and a filter are arranged in an optical switch housing. These optical components are secured at required positions by an adhesive, and of course there is a requirement for high reliability of adhesion in the operating environment. Particularly, for the adhesion of the optical components arranged on an optical path, low optical loss on an adhesive interface is required. Bubbles remaining in the adhesive, that is, between the adhesive surface of the optical component and an adherend surface have an effect on the adhesion reliability and low optical loss of the optical components. In this regard, it can be considered to use a vacuum-drawing degassing technique as disclosed for example in reference document 3.
Reference document 3: Japanese Laid-open Patent Publication No. 2003-029035

Moreover, besides the degassing technique disclosed in the reference document 3, there are the degassing techniques disclosed in reference documents 4 and 5, and further, a preheated degassing technique and a rotational degassing technique. However, all of these degassing techniques require an apparatus for degassing, and the optical component need to be set in the degassing apparatus to perform degassing. Particularly, when adhesion of a micro lens in a collimator array required for an optical switch that uses an MEMS mirror array is taken into consideration, jig design for setting the optical components in the degassing apparatus becomes complicated, and the operation required for the setting takes time and labor.
Reference document 4: Japanese Laid-open Patent Publication No. 2005-091595
Reference document 5: Japanese Laid-open Patent Publication No. 2006-071766

### SUMMARY

According to an aspect of the embodiment, an adhesive surface structure of an optical component proposed herein includes; a plurality of ridge portions extending linearly and radially from one point on an adhesive surface, and valley portions formed in a configuration that a central line between respective the ridge portions inclines to be away from an adherend surface as it goes away from the one point.

Additional objects and advantage of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1A is a perspective view illustrating an adhesive surface of an optical component according to a first embodiment.

FIG. 1B is a plan view and side views illustrating the adhesive surface of the optical component according to the first embodiment.

FIG. 2 is an explanatory view illustrating a situation as viewed sideways, for when the optical component according to the first embodiment is bonded to an adherend surface.

FIG. 3 is an explanatory view illustrating a situation as seen from the adherend surface side, for when the optical component according to the first embodiment is bonded to the adherend surface.

FIG. 4 is a plan view and side views illustrating an adhesive surface of an optical component according to a second embodiment.

FIG. 5 is a plan view and side views illustrating an adhesive surface of an optical component according to a third embodiment.

FIG. 6 is a plan view and side views illustrating an adhesive surface of an optical component according to a fourth embodiment.

FIG. 7 is an explanatory view illustrating a bonding process of the optical component.

FIG. 8 is an explanatory view illustrating a situation as seen from the side, for when an optical component in the related art is bonded to the adherend surface.

FIG. 9 is an explanatory view illustrating a situation as seen from the adherend surface side, for when the optical component in the related art is bonded to the adherend surface.

FIG. 10 is an explanatory view illustrating scrubbing for pushing out bubbles.

### DESCRIPTION OF EMBODIMENTS

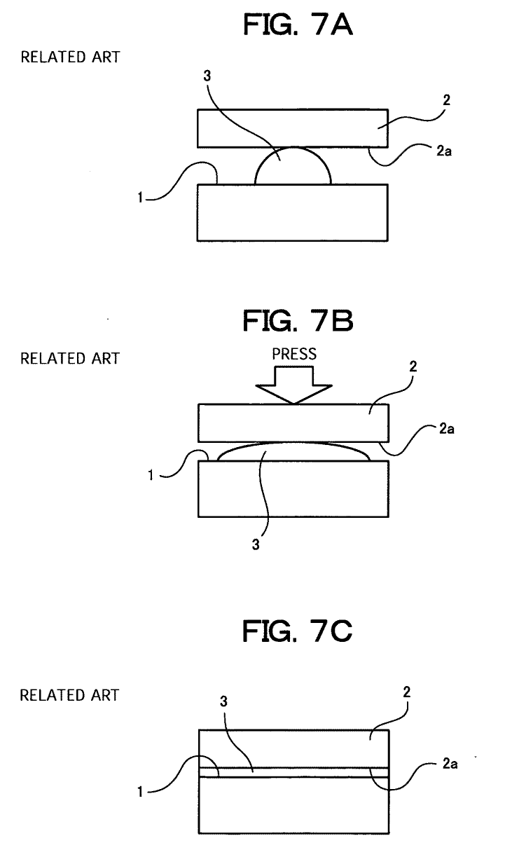

The cause of bubbles mixed between the adhesive surface of the optical component and the adherend surface is considered here with reference to FIG. 7 to FIG. 10. At first, FIG. 7 illustrates a situation for when an optical component 2 such as a mirror or a prism is pressed against and bonded to an adherend surface 1 such as a frame. In FIG. 7A, a degassed adhesive 3 is applied to the adherend surface 1, and the optical component 2 is positioned thereabove. In FIG. 7B, pressure is applied to the optical component 2 to press an adhesive surface 2a against the adherend surface 1, so that the adhesive 3 is pressed and spread out between the adherend surface 1 and the adhesive surface 2a. In FIG. 7C, once the adhesive 3 has spread all over between the adherend surface 1 and the adhesive surface 2a, the adhesive 3 is hardened.

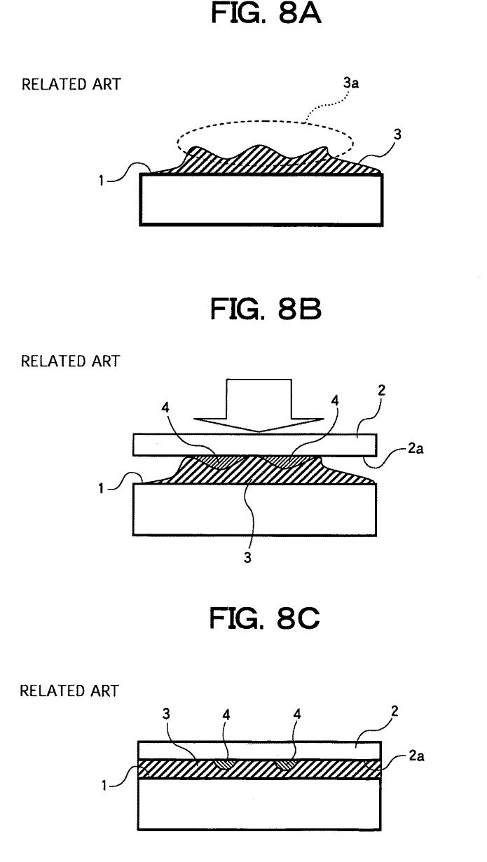

A situation of the adhesive surface 2a and the adhesive 3 at this time is illustrated enlarged in FIG. 8. In FIG. 8A, a surface 3a of the adhesive 3 applied to the adherend surface 1 in FIG. 7A actually has a slightly wavy condition. In FIG. 8B, when the adhesive surface 2a of the optical component 2 is pressed from above against the wavy surface 3a of the adhesive 3, a recess (valley portion of the wave) on the surface 3a is capped, so that the atmosphere 4 is confined. In FIG. 8C, when the optical component 2 is pressed in this state, there is no escape for the confined atmosphere 4, thereby causing bubbles.

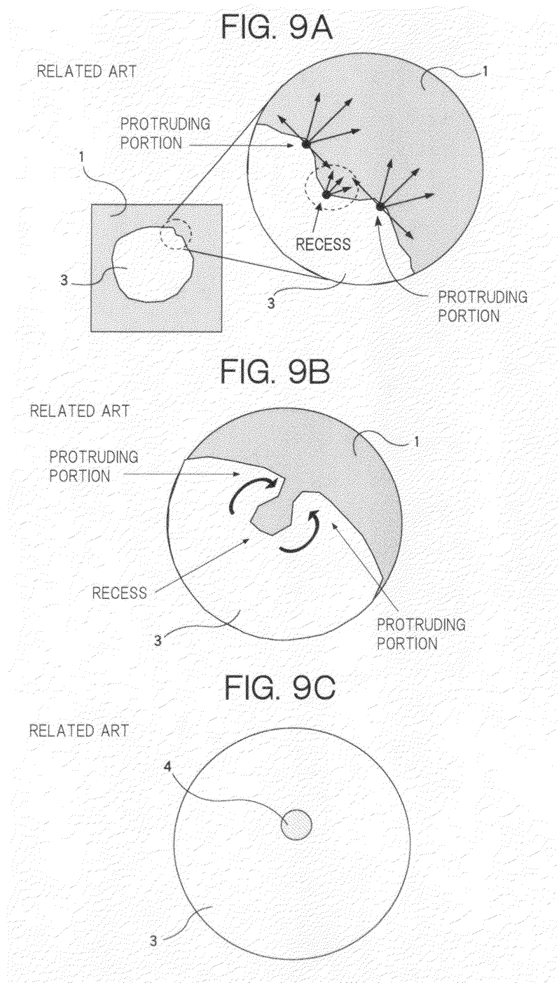

FIG. 9 illustrates another cause of generating bubbles. In FIG. 9A, when the adhesive 3 is pressed and spread out in FIG. 7B, actually, there are many irregular convex portions and concave portions at the periphery of the pressed and spread out adhesive 3. For the recess (concave portion), since the thickness of the adhesive 3 is thinner than in other parts, the spreading force is weak, whereas for the convex portion, since the thickness of the adhesive 3 is thicker than in the recess, the spreading force is strong. Accordingly, there is spreading nonuniformity between these, and as illustrated by the arrows in FIG. 9A, larger (faster) spreading is seen in the convex portion than in the recess. In FIG. 9B, due to this spreading nonuniformity, the fast spreading convex portion goes around ahead of the slow spreading recess. In FIG. 9C, when the convex portion which has gone around ahead, closes off to bond to each other before the recess spreads, the atmosphere 4 is confined thus causing bubbles.

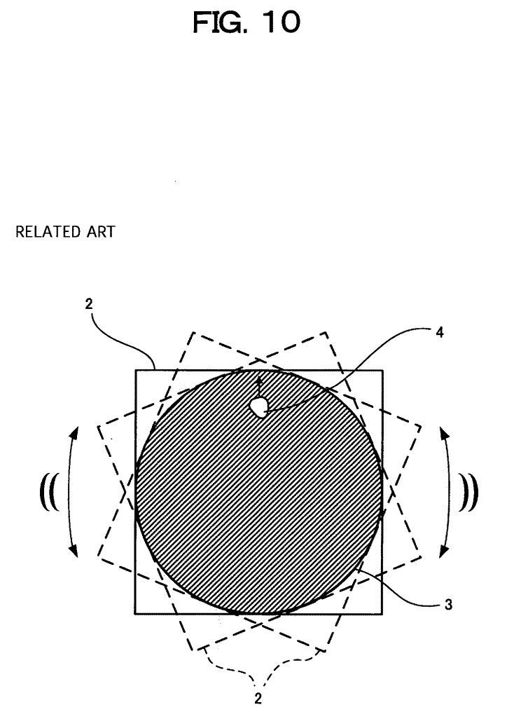

Such bubbles 4 can be generated even if the above-described degassing apparatus is used. Therefore, when the bubbles 4 are generated, for example as illustrated in FIG. 10, a degassing operation for scrubbing (squeezing) the optical component 2 to push out the bubbles 4 to the outside is required. When bubbles are generated near the outer periphery of the adhesive 3, these can be easily pushed out by scrubbing. However, when the bubbles generated and left inside near the center, it is not easy to push out them by scrubbing, and further, time and labor are required.

In view of the above point, an optical component having a structure which hardly generates bubbles at the time of adhesion by devising an adhesive surface structure of the optical component, should be proposed, in order to enable adhesion without using the degassing apparatus or scrubbing as much as possible.

According to the adhesive surface structure of the optical component proposed herein, a valley portion is formed between ridge portions extending linearly and radially on the adhesive surface, so that a bottom of the valley inclines so as to be away from the adherend surface as it goes outward. The inclined valley portion which presents between the ridge portions prevents the aforementioned confinement of the- atmosphere on the surface of the adhesive. That is to say, when the adhesive surface is pressed against the adhesive, if the adhesive surface is flat, the recess on the surface of the adhesive is capped to confine the atmosphere as described above. However, in the adhesive surface structure according to the present proposal, the inclined valley portion prevents the recess from being capped, and furthermore, inclination of the valley portion provides an escape path for setting the atmosphere free outward, so that the atmosphere can be pushed out without being confined. In other words, the inclined valley portion acts to push out the atmosphere on the surface of the adhesive outwards, and hence generation of bubbles is suppressed.

Moreover, according to the adhesive surface structure of the optical component according to the present proposal, the central line between the respective ridge portions extending linearly and radially from one point, becomes the bottom of the valley and inclines. The adhesive is subjected to the same force from slopes of the valley extending from the adjacent ridge portions toward the central line, that is, from two slopes on the opposite sides, and is pressed outward, and is pushed out from the one point as a starting point of each ridge portion through the valley portions towards the periphery. That is to say, the adhesive spreads from the inside to the outside so as to push out the atmosphere from the inside. In the case of the flat adhesive surface in the aforementioned explanation, it is considered that since the adhesive is only pressed and spread out by the flat adhesive surface, it lacks a constant force to pressed and spread out the adhesive from the inside to the outside, and the spreading direction of the adhesive is not constant, thus causing nonuniformity, so that the wraparound in the aforementioned explanation occurs. However, according to the adhesive surface structure of the present proposal, this problem is resolved, and confinement of the atmosphere due to the spreading nonuniformity of the adhesive hardly occurs, and the generation of bubbles is suppressed.

In this manner, since the generation of bubbles can be suppressed by designing the adhesive surface structure of the optical component, the above-described degassing apparatus and scrubbing can be made unnecessary.

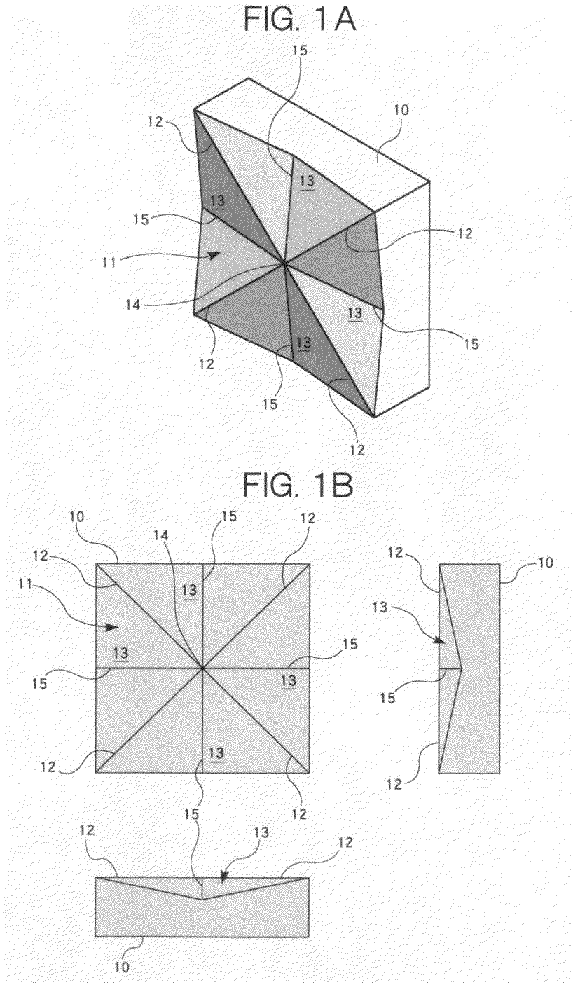

FIG. 1 illustrates an adhesive surface structure of an optical component according to a first embodiment. The optical component in the first embodiment is a rectangular solid optical component such as a mirror or a prism used in an optical switch that adopts the MEMS. FIG. 1A is a perspective view of the optical component, with the adhesive surface to the front side, and FIG. 1B is a plan view and side views thereof as seen from the adhesive surface side.

An adhesive surface 11 of an optical component 10 exhibits a three-dimensional shape including ridge portions 12, and valley portions 13 between the respective ridge portions 12. The ridge portions 12 are straight ridges extending radially from one point 14 on the adhesive surface 11. On the other hand, the valley portions 13 are recesses formed so that a central line 15 between respective ridge portions 12 inclines to be away from the adherend surface (not illustrated) opposite to the adhesive surface 11, as it goes away from the one point 14. In other words, the central line 15 forms a slope toward the periphery of the adhesive surface 11.

In the case of the first embodiment, the adhesive surface 11 is square, and a central point of the square is the one point 14. Furthermore the four ridge portions 12 extending radially from the one point 14 are arranged along diagonals of the square. Consequently, the lengths of the respective ridge portions 12 in the first embodiment (the length from the one point 14 to the periphery of the adhesive surface 11) are equal to each other. That is to say, the adjacent ridge portions 12 have the same length, and exhibit an isosceles triangle, with the periphery of the adhesive surface 11 being the base. The valley portion 13 formed between the ridge portions 12 forms a V-shaped valley with the central line 15 being the bottom of the valley.

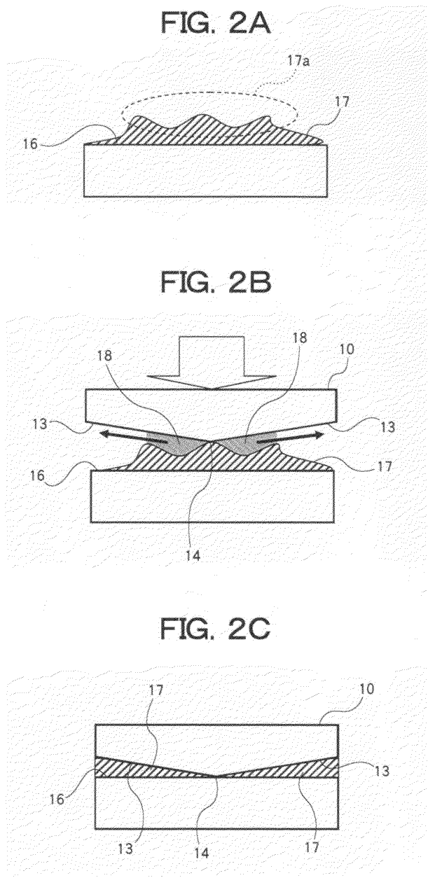

FIG. 2 illustrates a situation of the adhesive surface 11 and an adhesive 17 for when the optical component 10 having the adhesive surface structure is pressed against and bonded to an adherend surface 16 such as a frame. In FIG. 2A, as described above, a surface 17a of the adhesive 17 applied on the adherend surface 16 is slightly wavy. In FIG. 2B, the adhesive surface of the optical component 10 is pressed against the wavy surface 17a of the adhesive 17 from above and from the one point 14. Then, since there is the inclined valley portion 13, the recess is not capped, and the escape path for setting the atmosphere 18 free outward is formed (illustrated by the arrows). Moreover the inclined valley portion 13 functions to push out the atmosphere 18 to the outside, as the optical component 10 is pressed. In FIG. 2C, when the optical component 10 is pressed until the adhesive 17 is spread all over between the adhesive surface of the optical component 10 and the adherend surface 16, the atmosphere 18 is pushed out to the outside, and the generation of the bubbles is suppressed. The inclination of the central line 15 which becomes the escape path of the atmosphere, can be appropriately designed according to the viscosity of the adhesive 17.

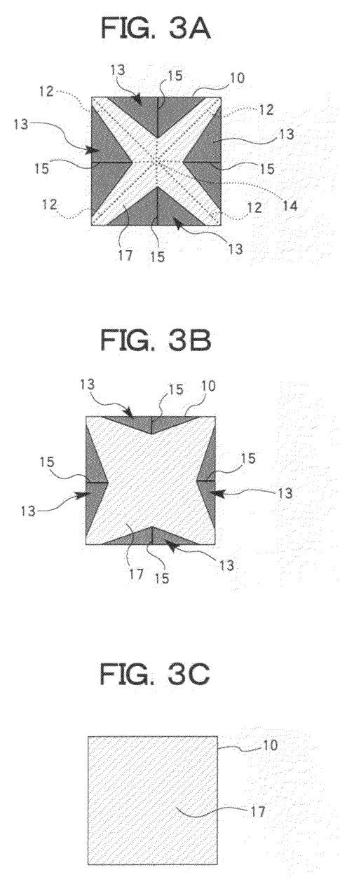

Furthermore, concerning the wraparound of the adhesive which is the above-mentioned other cause of the generating bubbles, this is resolved by the adhesive 17 being pushed out through the valley portion 13, while being pressed by the adjacent ridge portions 12 forming the isosceles sides. FIG. 3 illustrates this situation. FIG. 3 is an explanatory view illustrating a spreading state of the adhesive 17 on the adhesive surface of the optical component 10, as seen from the adherend surface side.

In FIG. 3A, when starting pressing of the optical component 10, the adhesive 17 at first adheres to the ridge portions 12, and then starts to spread toward the valley portions 13. In FIG. 3B, since the central line 15 serving as the bottom of the valley portion 13 inclines outward, the adhesive 17 is pushed out from the one point 14 outward through the valley portion 13. At this time, the adhesive 17 is pressed by the slope of the valley extending from the adjacent ridge portions 12 toward the central line 15. Then, since these ridge portions 12 form the isosceles sides, the extrusion forces applied to the adhesive 17 from the opposite slopes are substantially equal to each other. Consequently, the adhesive 17 is subjected to a pressing force substantially uniformly from the opposite slopes. In this manner, the adhesive 17 is pressed through the valley portion 13 having the inclined bottom of the valley, by the slopes of the ridge portions 12 on the two sides extending in a V shape from the one point 14, and hence the adhesive 17 spreads from the inside to the outside to push out the atmosphere from the inside. That is to say, confinement of the atmosphere due to the spreading nonuniformity of the adhesive as explained above hardly occurs, and the generation of bubbles is suppressed. In FIG. 3C, the adhesive 17 spreads all over between the adhesive surface of the optical component 10 and the adherend surface, without generating bubbles in which the atmosphere is confined.

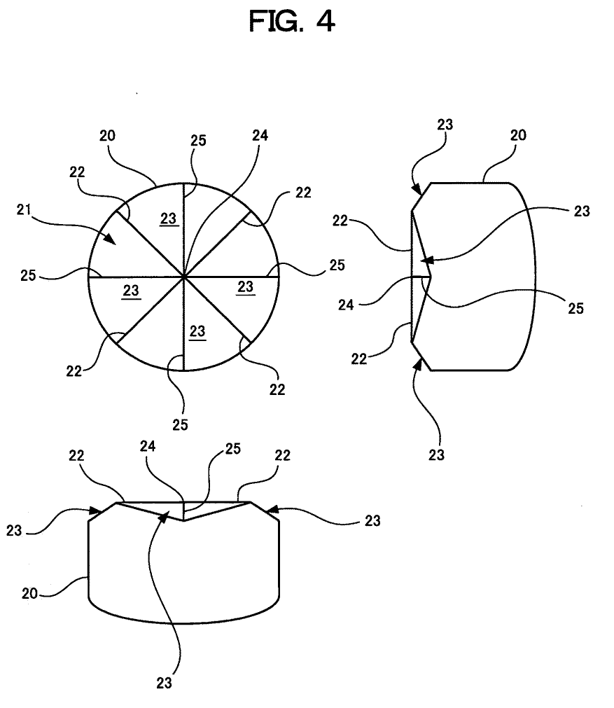

FIG. 4 illustrates a plan view and side views as seen from the adhesive surface side, of a columnar optical component such as a micro lens used in a collimator, as a second embodiment.

An optical component 20 has a columnar shape with a surface on an opposite side to an adhesive surface 21 being a lens surface, and is used for converting outgoing beams from an optical fiber, into parallel beams, and the like. The adhesive surface 21 thereof has a three-dimensional shape including ridge portions 22, and valley portions 23 between the ridge portions 22. The adhesive surface 21 in the second embodiment is circular, and the ridge portions 22 are formed as ridges extending radially (in a radial direction) and linearly from a central point 24 serving as the one point. That is to say, since each ridge portion 22 corresponds to a radial line of a circle, their lengths are equal to each other. Moreover the circumferential spaces between the ridge portions 22 are equal. In the example illustrated in FIG. 4, since four ridge portions 22 are formed, the space therebetween is 90 degrees.

The valley portions 23 formed between the ridge portions 22 are in a fan shape, and form V-shaped valleys with a central line 25 between the ridge portions being the bottom of the valley. The valley portions 23 are recesses formed so that the central line 25 inclines to be away from an adherend surface opposite to the adhesive surface 21, as it goes away from the central point 24. In other words, the central line 25 is the bottom of the valley portion 23, which is a slope toward the periphery of the adhesive surface 21.

In this manner, even if the optical component is columnar or conical and the adhesive surface thereof is circular (perfect circle or oval), the same adhesive surface structure as that of the first embodiment can be formed, and the same effects can be obtained. Moreover, the optical component provided with the lens surface on the opposite side to the adhesive surface as illustrated in FIG. 4 can be used as the micro lens, and a collimator array including such a micro lens can be used in combination with a MEMS mirror, and this optical component can be applied to a module of a wavelength-selective optical switch.

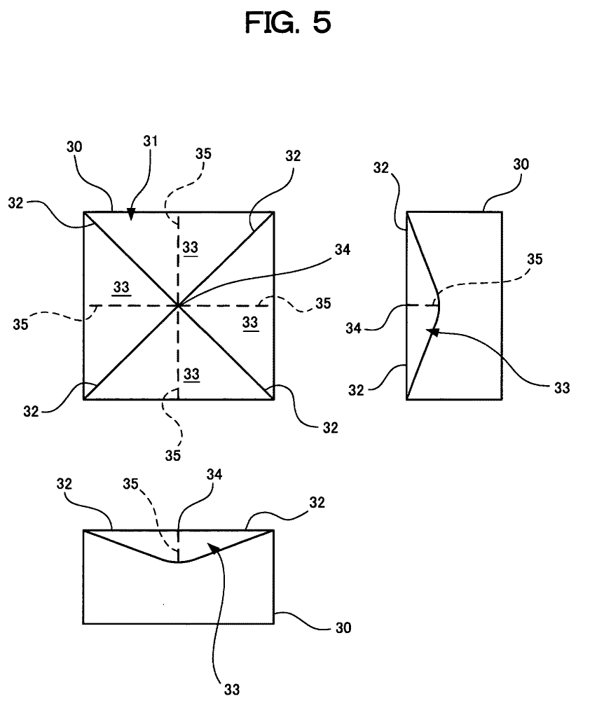

FIG. 5 illustrates a third embodiment in which the valley portion shape is modified, in a plan view and side views as seen from the adhesive surface side. The third embodiment is illustrated in an example applied to a rectangular solid optical component the same as in the first embodiment.

In an adhesive surface 31 of an optical component 30, ridge portions 32 are the same as those in the first embodiment, but valley portions 33 have a different shape in the bottom of the valley. Moreover one point 34 and central lines 35 are the same as those in the first embodiment. In the valley portion 33 in the third embodiment, there is also the same as those in the first embodiment in that the central line 35 passes through the bottom of the valley, but the bottom of the valley through which the central line 35 passes (refer to the side views) is rounded. That is to say, in the case of the valley portion 13 in the first embodiment, the corner where the central line 15 is the fold line is formed at the bottom of the valley. However, in the case of the valley portion 33 in the third embodiment, the bottom of the valley through which the central line 35 passes is rounded, namely, the corner is rounded. The adhesive surface structure in the third embodiment is machined more easily, as compared to the adhesive surface structure in the first embodiment.

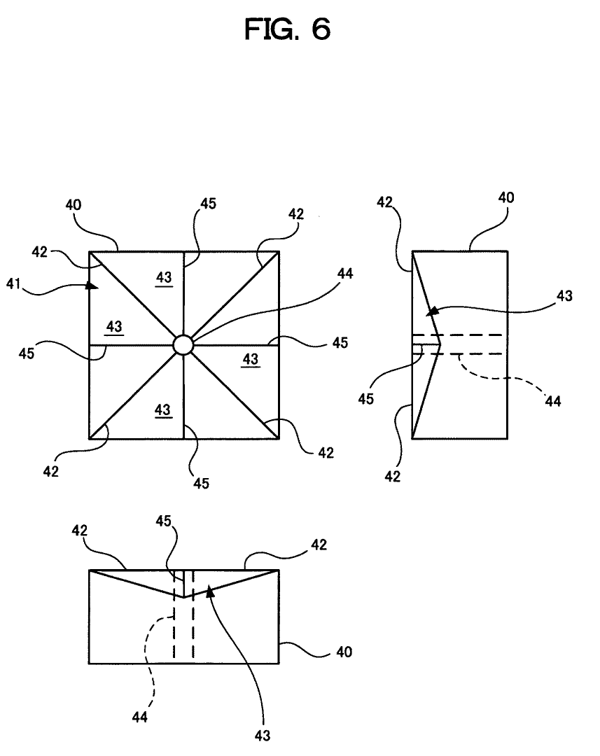

FIG. 6 illustrates a fourth embodiment in which a through hole is provided at a portion of one point serving as the starting point of the ridge portions, in a plan view and side views as seen from the adhesive surface side. The fourth embodiment also is illustrated in an example applied to a rectangular solid optical component the same as in the first embodiment.

Ridge portions 42 and valley portions 43 the same as those in the first embodiment are formed on an adhesive surface 41 of an optical component 40. A through hole 44 penetrating to the backside is bored at the position of one point serving as the starting point of the ridge portions 42. Consequently, respective ridge portions 42 extend from the through hole 44 radially and linearly. Similarly, central lines 45 between the ridge portions 42 also extend from the through hole 44 to a periphery of the adhesive surface 41.

The through hole 44 can be used for feeding the adhesive to between the adhesive surface 41 and the adherend surface. By feeding the adhesive from the through hole 44, the adhesive can be surely supplied from the starting point (base end) of the ridge portions 42 and the valley portions 43, and hence, the atmosphere hardly remains.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An adhesive surface structure of an optical component comprising:
a plurality of ridge portions extending linearly and radially from one point on an adhesive surface; and
valley portions formed in a configuration that a central line between respective ridge portions inclines to be away from an adherend surface as it goes away from the one point.

2. An adhesive surface structure of an optical component according to claim 1, wherein
lengths of adjacent ridge portions are the same.

3. An adhesive surface structure of an optical component according to claim 2, wherein:
the adhesive surface is rectangular or square; and
the one point is a central point of the adhesive surface, and the ridge portions are arranged along diagonals of the adhesive surface.

4. An adhesive surface structure of an optical component according to claim 1, wherein
a through hole penetrating to a backside is provided at a position of the one point in the adhesive surface.

5. An adhesive surface structure of an optical component according to claim 1, wherein
a bottom of the valley through which the central line passes is rounded.

6. A collimator comprising a micro lens, wherein the micro lens includes an adhesive surface having an adhesive surface structure comprising:
a plurality of ridge portions extending linearly and radially from one point on the adhesive surface; and
valley portions formed in a configuration that a central line between respective ridge portions inclines to be away from an adherend surface as it goes away from the one point.

7. An adhesive surface structure of a rectangular solid optical component comprising:
ridge portions extending along diagonals from a central point of a rectangular or square adhesive surface; and
valley portions formed in a configuration that a central line between respective ridge portions inclines to be away from an adherend surface as it goes away from the central point.

8. An adhesive surface structure of a columnar optical component comprising:
ridge portions extending in a radial direction from a central point of a circular adhesive surface and arranged at equal spacing in a circumferential direction; and
valley portions formed in a configuration that a central line between respective ridge portions inclines to be away from an adherend surface as it goes away from the central point.

9. A columnar optical component comprising:
an adhesive surface; and
a lens surface is formed on a surface on an opposite side to the adhesive surface,
wherein the adhesive surface has an adhesive surface structure comprising:
ridge portions extending in a radial direction from a central point of a circular adhesive surface and arranged at equal spacing in a circumferential direction; and
valley portions formed in a configuration that a central line between respective ridge portions inclines to be away from an adherend surface as it goes away from the central point.

10. A collimator in which a columnar optical component which comprises an adhesive surface and a lens surface formed on a surface on an opposite side to the adhesive surface, is used as a micro lens,
wherein the adhesive surface of the columnar optical component has an adhesive surface structure comprising:
ridge portions extending in a radial direction from a central point of a circular adhesive surface and arranged at equal spacing in a circumferential direction; and
valley portions formed in a configuration that a central line between respective ridge portions inclines to be away from an adherend surface as it goes away from the central point.
